(19) United States
(12) Patent Application Publication
(10) Pub. No.: US 2025/0385448 A1
(43) Pub. Date: Dec. 18, 2025

(54) TERMINAL AND CONNECTION STRUCTURE BETWEEN TERMINAL AND BUSBAR

(71) Applicant: SUMITOMO WIRING SYSTEMS, LTD., Mie (JP)

(72) Inventor: Daisuke KATAOKA, Mie (JP)

(21) Appl. No.: 19/111,275

(22) PCT Filed: Aug. 30, 2023
(86) PCT No.: PCT/JP2023/031376

§ 371 Date: Mar. 12, 2025

(30) Foreign Application Priority Data
Sep. 20, 2022 (JP) 2022-148979

(51) Int. Cl. H01R 11/28

(52) U.S. Cl. CPC H01R 11/282; H01R 2201/26

(57) ABSTRACT

A terminal (10, 10A, 10B) is to be connected to a busbar (80) having an arm (82) extending from a busbar body (81). The terminal (10, 10A, 10B) includes: a wire connection portion (12) to which an electric wire (60) is to be electrically connected; a busbar fixing portion (13) to be fixed and electrically connected to the busbar body (81) or the arm (82); and a positioning portion (11) for positioning the terminal (10, 10A, 10B) relative to the arm (82). The busbar fixing portion (13) is located between the wire connection portion (12) and the positioning portion (11).

### TECHNICAL FIELD

The present disclosure relates to a terminal and a connection structure between a terminal and a busbar.

### BACKGROUND

Patent Document 1 discloses a connection structure between a terminal and a busbar. The terminal has a wire connection portion to which an electric wire is electrically connected, a busbar fixing portion fixed and electrically connected to an arm, and an arm fixing portion located between the wire connection portion and the busbar fixing portion and fixed to the arm.

Connection structures between the terminal and the busbar are also disclosed in Patent Documents 2 and 3. Patent Document 4 discloses a molded body that is molded by processing a clad steel plate in which a base material of a busbar body and a base material of a joint terminal are joined.

### PRIOR ART DOCUMENT

### Patent Document

Patent Document 1: JP 2017-092030 A

Patent Document 2: JP 2014-154339 A

Patent Document 3: JP 2014-060093 A

Patent Document 4: JP 2019-008877 A

### SUMMARY OF THE INVENTION

### Problems to be Solved

In Patent Document 1, the busbar fixing portion is arranged at a distance from the wire connection portion at a position separated therefrom via the arm fixing portion. Thus, if an external force acts on the wire connection portion due to, for example, a wire being pulled or vibrating, and the fixing function of the arm fixing portion is impaired, a large bending moment may occur in the busbar fixing portion and also impair the fixing function of the busbar fixing portion.

The present disclosure aims to provide a terminal and a connection structure between a terminal and a busbar that can maintain the fixing function of the busbar fixing portion.

### Means to Solve the Problem

A terminal of the present disclosure is a terminal to be connected to a busbar having an arm extending from a busbar body, the terminal including: a wire connection portion to which an electric wire is to be electrically connected; a busbar fixing portion to be fixed and electrically connected to the busbar body or the arm; and a positioning portion for positioning the terminal relative to the arm, wherein the busbar fixing portion is located between the wire connection portion and the positioning portion.

### Effect of the Invention

According to the present disclosure, it is possible to provide a terminal and a connection structure between a terminal and a busbar that can maintain the fixing function of the busbar fixing portion.

### BRIEF DESCRIPTION OF THE DRAWINGS

FIG. 1 is a plan view of a busbar module that connects a terminal and a busbar in Embodiment 1 of the present disclosure.

FIG. 2 is an enlarged perspective view of a main part of the busbar.

FIG. 3 is an enlarged plan view of a main part of FIG. 1.

FIG. 4 is an enlarged side view of the main part of FIG. 1.

FIG. 5 is a cross-sectional view of a connecting section between a positioning portion and an arm.

FIG. 6 is a cross-sectional view of a connecting section between a busbar fixing portion and the arm.

FIG. 7 is a plan view of a busbar module that connects a terminal and a busbar in Embodiment 2 of the present disclosure.

FIG. 8 is a side view of FIG. 7.

FIG. 9 is an enlarged front view of a main part of FIG. 7.

FIG. 10 is a plan view of a busbar module that connects a terminal and a busbar in Embodiment 3 of the present disclosure.

### DETAILED DESCRIPTION TO EXECUTE THE INVENTION

### Description of Embodiments of Present Disclosure

Firstly, modes for carrying out the present disclosure are listed and described.
(1) A terminal of the present disclosure is a terminal to be connected to a busbar having an arm extending from a busbar body, the terminal including: a wire connection portion to which an electric wire is to be electrically connected; a busbar fixing portion to be fixed and electrically connected to the busbar body or the arm; and a positioning portion for positioning the terminal relative to the arm, wherein the busbar fixing portion is located between the wire connection portion and the positioning portion.

According to this configuration, the positioning portion is not interposed between the busbar fixing portion and the wire connection portion, thereby allowing the busbar fixing portion to be positioned near the wire connection portion. Thus, when an external force acts on the wire connection portion due to vibration or the like of the electric wire, the occurrence of a large bending moment in the busbar fixing portion can be avoided. Accordingly, the fixing function of the busbar fixing portion can be maintained even if an external force acts on the wire connection portion. Further, the positioning portion is aligned with the arm, allowing the connection position of the busbar fixing portion relative to the busbar to be determined at a proper position.
(2) It is preferable that the positioning portion is fixed to the arm.

According to this configuration, the fixing function of the positioning portion is added to the fixing function of the busbar fixing portion, allowing the terminal to be stably fixed to the busbar.
(3) It is preferable that the positioning portion has a positioning reference portion that is aligned with the same position as an end surface of the arm.

According to this configuration, when connecting the terminal to the busbar, the terminal can be easily positioned relative to the busbar based on the position of the positioning reference portion.
(4) It is preferable that the positioning portion has a positioning reference portion at a position at which the positioning portion faces an end surface of the arm so as to be able to come into contact therewith.

According to this configuration, when connecting the terminal to the busbar, the position where the positioning reference portion abuts against the end surface of the arm can be used as a reference for positioning, so that the terminal can be automatically positioned relative to the busbar.
(5) A connection structure between a terminal and a busbar preferably includes the terminal according to any of (1) to (4) and the busbar. It is preferable that the arm has: an arm body extending from one end surface to another end surface; and a joint portion extending in a direction intersecting with an extension direction of the arm body and connecting the arm body and the busbar body, the positioning portion is located on the one end surface side of the arm body, and the busbar fixing portion is located on the other end surface side of the arm body.

According to this configuration, when connecting the terminal to the busbar, the positioning portion and the busbar fixing portion can be easily arranged relative to the arm.

### Details of Embodiments of the Present Disclosure

Specific examples of the present disclosure are described below with reference to the drawings. Note that the present invention is not limited to these examples but is defined by the claims, and is intended to include all changes made within the meaning and scope equivalent to the claims.

### Embodiment 1

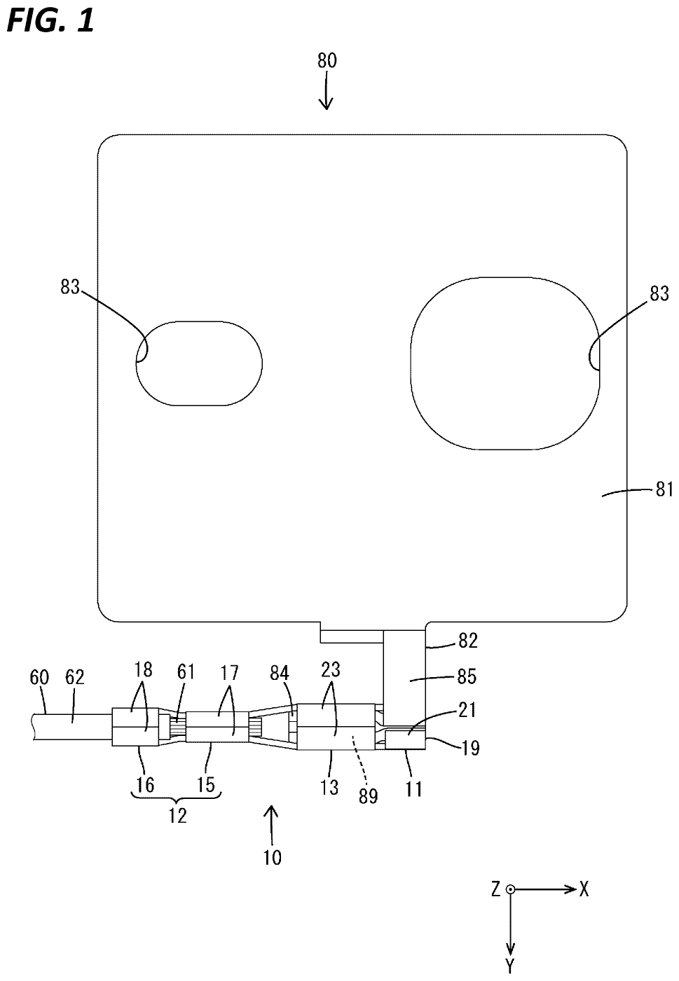

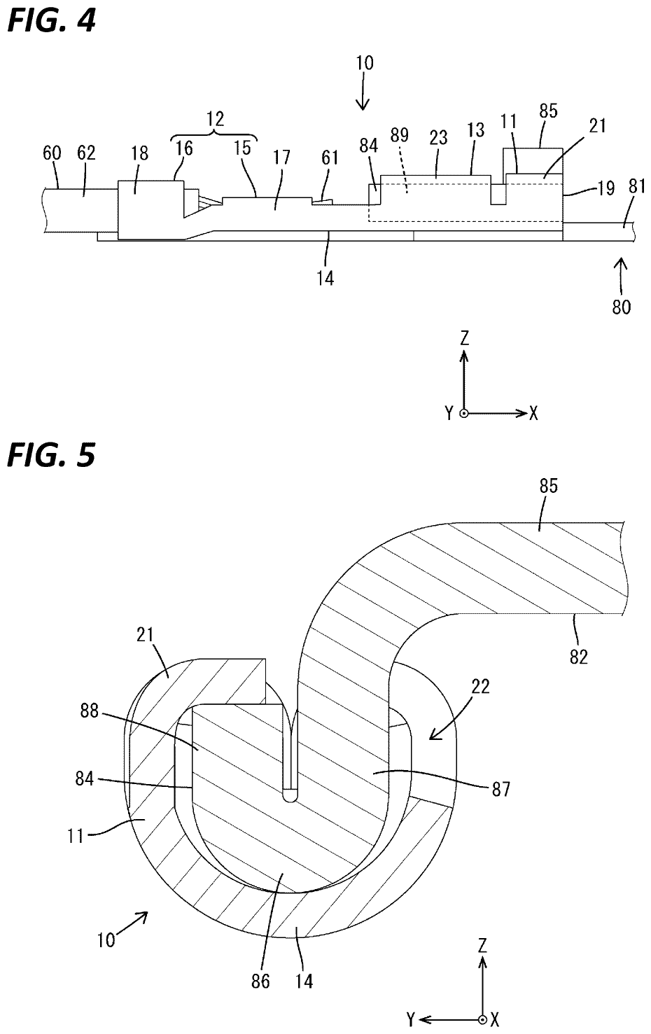

As shown in FIG. 1, a terminal 10 according to Embodiment 1 of the present disclosure is a terminal interposed between a busbar 80 and an electric wire 60, and constitutes a busbar module together with the busbar 80. In the following description, the front-back direction is defined such that the front side corresponds to the right side in FIG. 1, and the up-down direction is defined such that the upper side corresponds to the upper side in FIG. 4. The left-right direction is defined such that the left side refers to the left side when viewed from the front side. In FIGS. 1 to 6, the “front”, “left”, and “upper” sides are denoted by symbols X, Y and Z, respectively. These directional references are merely for convenience and do not necessarily coincide with directional references when mounted on a vehicle (not shown) or the like.

### Electric Wire

The electric wire 60 of Embodiment 1 extends from, for example, a voltage detection device (not shown), and has a terminal portion facing forward and connected to the terminal 10. As shown in FIGS. 1 and 4, the electric wire 60 is a coated wire in which the outer periphery of a conductor 61, which is constituted by a core wire or the like, is covered with a coating 62, which is made of insulating resin. The coating 62 is removed at the terminal portion of the electric wire 60 to expose the conductor 61.

### Busbar

Although not shown, the busbar 80 illustrated in Embodiment 1 is a busbar that is to be welded to electrode terminals protruding from a plurality of batteries provided in a power supply device. Note that the power supply device may be a power supply device that is mounted on an electric vehicle, a hybrid vehicle, or the like and supplies electric power to an electric motor.

The busbar 80 is a plate material made of conductive metal, and has a busbar body 81 and an arm 82 protruding from the busbar body 81, as shown in FIG. 1.

The busbar body 81 has a rectangular flat plate shape, and is arranged with its plate surfaces facing in the up-down direction. The busbar body 81 has two through-holes 83 through which protruding parts of the aforementioned electrode terminals are to be passed. Although the through-holes 83 shown in the figure have different opening shapes, they may have the same opening shape.

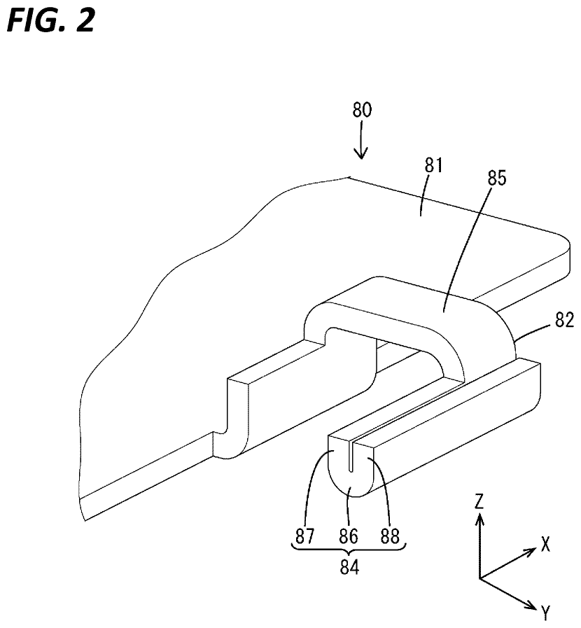

The arm 82 has a size relatively smaller than the busbar body 81, and has a shape bent from the busbar body 81 and extending long. As shown in FIG. 2, the arm 82 has an arm body 84 spaced apart from one edge (left edge) of the busbar body 81 and extending in the front-back direction parallel with the one edge of the busbar body 81, and a joint portion 85 extending in the left-right direction and connecting the one edge of the busbar body 81 and the arm body 84.

The arm body 84 has a U-shaped cross-section and has a bent portion 86 that is bent downward in its intermediate area in the left-right direction, a first arm portion 87 that rises from the right side (the side closer to the busbar body 81) of the bent portion 86, and a second arm portion 88 that rises from the left side (the side farther from the busbar body 81) of the bent portion 86. As shown in FIG. 4, the arm body 84 is located above the busbar body 81 via the joint portion 85.

As shown in FIG. 2, the joint portion 85 has a bent plate shape, protrudes upward from the one edge of the busbar body 81, then extends in the leftward direction, and is bent downward from the left end and connected to the upper end surface of the front end portion of the first arm portion 87.

### Terminal

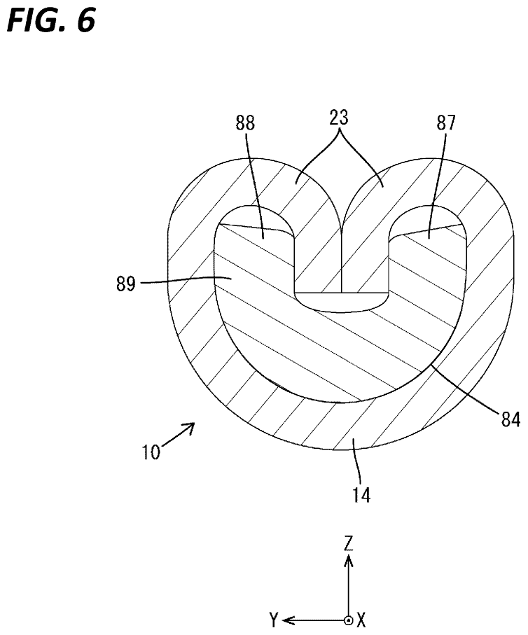

The terminal 10 is a plate material made of conductive metal and has a shape extending long in the front-back direction. As shown in FIG. 1, the terminal 10 is spaced apart from the one edge of the busbar body 81 and parallel therewith. The terminal 10 has a positioning portion 11 at its front end (an end on one end surface side (front end surface side)), a wire connection portion 12 at its rear end (an end on the other end surface side (rear end surface side)), and a busbar fixing portion 13 between the positioning portion 11 and the wire connection portion 12. As shown in FIG. 4, the terminal 10 has a base 14 extending over the entire length in the front-back direction. The base 14 constitutes bottom wall sections of the positioning portion 11, the wire connection portion 12, and the busbar fixing portion 13, and is shaped such that the central area in the left-right direction is curved downward (see FIGS. 5 and 6) by means of crimping, which will be described later.

The wire connection portion 12 has a wire barrel portion 15, which is connected to the conductor 61 of the electric wire 60 by means of crimping, and an insulation barrel portion 16, which is connected to the coating 62 of the electric wire 60 by means of crimping. As shown in FIG. 1, the wire barrel portion 15 is located forward of the insulation barrel portion 16 and is next thereto in the front-back direction. The wire barrel portion 15 and the insulation barrel portion 16 have respective barrel pieces 17 and 18 that rise from the left and right sides of the base 14 and face each other. Each barrel piece 17 of the wire barrel portion 15 is crimped and fixed to the outer periphery of the conductor 61 of the electric wire 60 and electrically connected to the conductor 61. Each barrel piece 18 of the insulation barrel portion 16 is crimped and fixed to the outer periphery of the coating 62 of the electric wire 60 and mechanically connected to the coating 62.

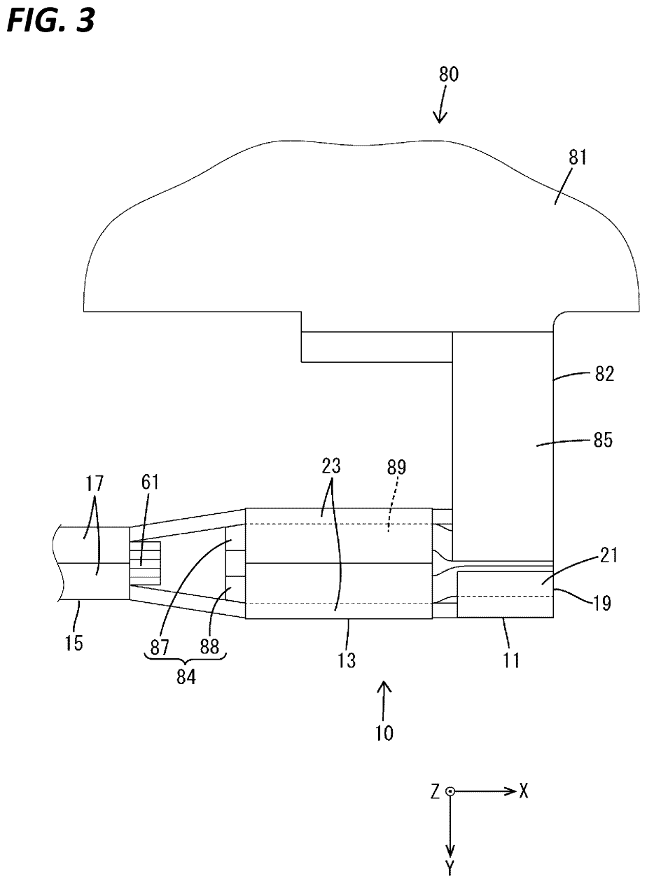

As shown in FIGS. 1 and 3, the positioning portion 11 is arranged in correspondence with the front end of the arm body 84. The front end surface of the positioning portion 11 is aligned with the front end surface of the arm 82, specifically the front end surface of the arm body 84 and the front end surface of the joint portion 85. In Embodiment 1, the front end surface of the positioning portion 11 constitutes a positioning reference portion 19 that serves as a reference for positioning the terminal 10 relative to the busbar 80.

As shown in FIG. 5, the positioning portion 11 has a positioning piece 21 that rises from the left side of the base 14. The base 14 of the positioning portion 11 faces the lower surface of the bent portion 86 of the arm body 84. A portion of the positioning piece 21 excluding the upper end faces the left side surface of the second arm portion 88. The upper end of the positioning piece 21 is bent rightward by means of crimping, and faces the upper end surface of the front end of the second arm portion 88. In Embodiment 1, the upper end of the positioning portion 11 is in contact with the upper end surface of the front end of the second arm portion 88, and is arranged such that the front end of the arm body 84 is sandwiched between the upper end of the positioning portion 11 and the base 14.

As shown in FIG. 5, the positioning portion 11 is bent in a curved shape as a whole. A space between the two ends in the circumferential direction of the positioning portion 11 constitutes an escape space 22 into which a joint section between the joint portion 85 and the first arm portion 87 enters.

As shown in FIGS. 1 and 3, the busbar fixing portion 13 is arranged in correspondence with the rear end (hereinafter referred to as a “fixed portion 89”) of the arm body 84. The busbar fixing portion 13 has fixing pieces 23 that rise from the left and right sides of the base 14 and face each other.

As shown in FIG. 6, the fixing pieces 23 are bent into a curved shape by means of crimping and face each other in an intermediate area in the left-right direction of the terminal 10 with the leading end surfaces of their bent shape facing downward. The fixing pieces 23 are in contact with the arm body 84 so as to wind the first arm portion 87 and the second arm portion 88 of the fixed portion 89, respectively, and are arranged such that the fixed portion 89 is sandwiched between the fixing pieces 23 and the base 14. The leading end surface of the bent shape of each fixing piece 23 enters a space formed between the first arm portion 87 and the second arm portion 88 at the fixed portion 89.

### Effect

When connecting the terminal 10 to the busbar 80, first, the base 14 of the busbar fixing portion 13 is arranged below the fixed portion 89 of the arm body 84, and the base 14 of the positioning portion 11 is arranged below the front end of the arm body 84. The fixing pieces 23 rising upward before being crimped are arranged on the left and right sides of the fixed portion 89 of the arm body 84, respectively, and the positioning piece 21 rising upward before being crimped is arranged on the left side of the front end of the second arm portion 88. Here, the positioning reference portion 19 is aligned with the same position in the front-back direction as the front end surface of the arm 82 (the front end surface of the arm body 84 or the front end surface of the joint portion 85) using vision, a jig, or the like (see FIG. 3). In other words, the front end surfaces of the positioning reference portion 19 and the arm 82 are arranged on a reference line extending along the left-right direction.

Next, the busbar fixing portion 13 is crimped to the fixed portion 89 of the arm body 84, and the positioning portion 11 is crimped to the front end of the arm body 84. In Embodiment 1, the crimping operation for the busbar fixing portion 13 and the positioning portion 11 can be performed simultaneously or separately in a state where they are positioned by the positioning reference portion 19. The fixing pieces 23 can thus be crimped and fixed to the fixed portion 89 of the arm body 84 at proper positions, and the positioning piece 21 can be crimped and fixed to the front end of the arm body 84 at a proper position.

Before or after the crimping operation for the busbar fixing portion 13 and the positioning portion 11, and preferably before the crimping operation, the conductor 61 and the coating 62 at the terminal portion of the electric wire 60 are connected to the wire barrel portion 15 and the insulation barrel portion 16 of the wire connection portion 12, respectively.

When the electric wire 60 is pulled or vibrates while being handled or routed, and an external force in a direction intersecting with the front-back direction acts on the terminal 10 from the electric wire 60, the external force may propagate from the wire connection portion 12 to the busbar fixing portion 13, and a bending moment may occur in the busbar fixing portion 13. Here, if a large bending moment occurs in the busbar fixing portion 13, there is a concern that the busbar fixing portion 13 is deformed. However, in Embodiment 1, the busbar fixing portion 13 and the wire connection portion 12 are adjacent to each other without the positioning portion 11 therebetween, as shown in FIG. 1. This can keep the bending moment occurring in the busbar fixing portion 13 small even when the external force acts. As a result, deformation of the busbar fixing portion 13 can be avoided, and the fixing function of the busbar fixing portion 13 with respect to the busbar 80 can be maintained.

Further, the terminal 10 can be positioned relative to the busbar 80 before the crimping operation is performed, by aligning the front end surface of the arm 82 and the positioning reference portion 19 of the terminal 10 with the same position in the front-back direction. As a result, the connection position (crimp position) of the terminal 10 to the busbar 80 can be properly determined.

Further, in Embodiment 1, the positioning portion 11 also has a fixing function with respect to the busbar 80 to assist the busbar fixing portion 13, thus allowing the terminal 10 to be stably fixed to the busbar 80.

### Embodiment 2

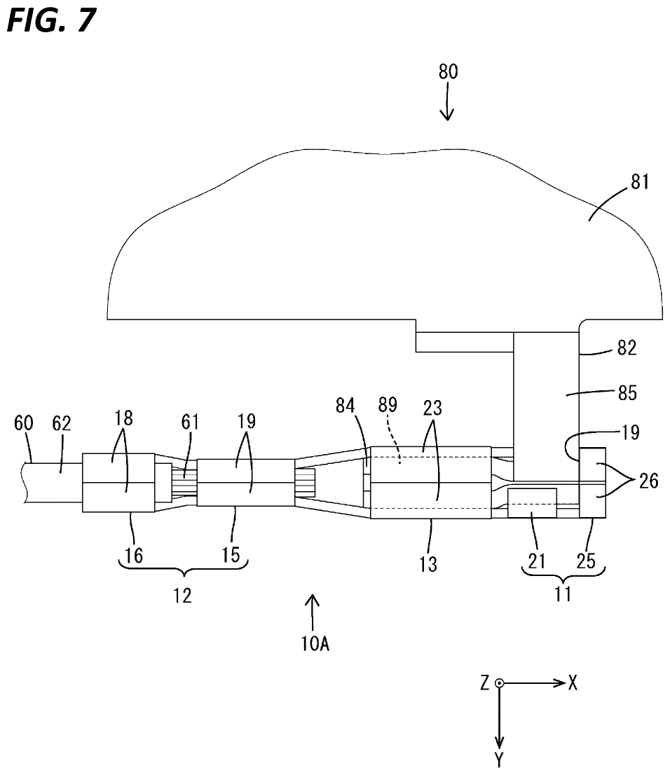

Embodiment 2 of the present disclosure shown in FIGS. 7 to 9 differs from Embodiment 1 in the structure of the positioning portion 11 of a terminal 10A. The rest is the same as Embodiment 1. In the following description, parts having the same functions (not limited to the same shapes) as those of Embodiment 1 are given the same reference numerals, and duplicate descriptions are omitted. In FIGS. 7 to 9, symbols X, Y, Z denote “front”, “left”, and “upper” sides, respectively.

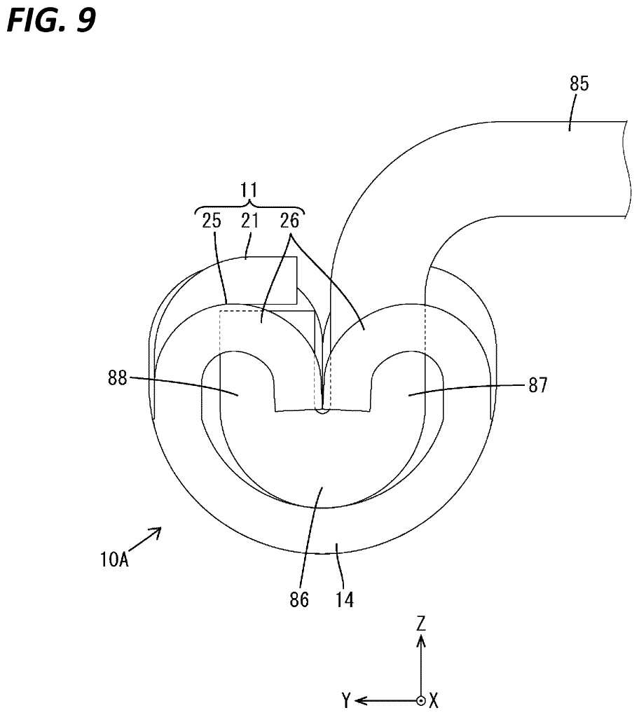

As shown in FIG. 7, the positioning portion 11 has a positioning piece 21 that rises from the left side of the base 14, and a stopper portion 25 located forward of the positioning piece 21. As shown in FIG. 9, the stopper portion 25 has stopper pieces 26 that rise from the left and right sides of the base 14 and face each other. The stopper pieces 26 are bent in a curved shape continuously from the base 14 and located at positions with an intermediate area in the left-right direction of the terminal 10A therebetween, and face each other with the leading end surfaces of their bent shape facing downward. The cross-sectional shape of each stopper piece 26 is the same as that of each fixing piece 23 of the busbar fixing portion 13. However, each stopper piece 26 does not have a shape for being crimped to the busbar 80, and the inside of the stopper piece 26 is hollow.

As shown in FIG. 7, the rear end surface of each stopper piece 26 is configured as a positioning reference portion 19 that faces the front end surface of the arm body 84 so as to be able to come into contact therewith from the front.

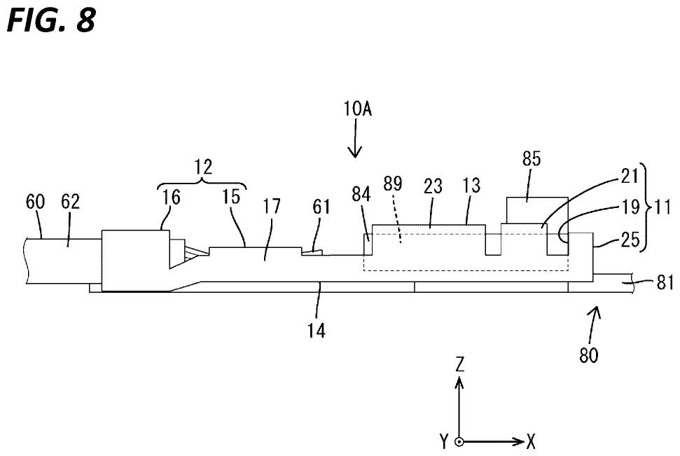

Before connecting the terminal 10B to the busbar 80, the stopper portion 25 is bent into the aforementioned shape in advance. In this state, the base 14 of the busbar fixing portion 13 is arranged below the fixed portion 89 of the arm body 84, and the base 14 of the positioning portion 11 is arranged below the front end of the arm body 84. The fixing pieces 23 rising upward before being crimped are arranged on the left and right sides of the fixed portion 89 of the arm body 84, and the positioning piece 21 rising upward before being crimped is arranged on the left side of the front end of the arm body 84. At this time, the positioning reference portion 19 of the stopper portion 25 is arranged forward of the front end surface of the arm body 84. Next, the terminal 10A is moved rearward relative to the arm body 84. Then, the positioning reference portions 19 of the stopper portion 25 abut against the front end surfaces of the first arm portion 87 and the second arm portion 88, respectively, stopping the operation of moving the terminal 10A relative to the arm body 84 (see FIGS. 7 and 8). Thus, in a subsequent crimping step, the fixing pieces 23 of the busbar fixing portion 13 can be crimped and fixed to the fixed portion 89 of the arm body 84 at proper positions, and the positioning piece 21 of the positioning portion 11 can be crimped and fixed to the front end of the arm body 84 at a proper position.

In Embodiment 2, the busbar fixing portion 13 is adjacent to the wire connection portion 12, thereby making it possible to keep a bending moment occurring in the busbar fixing portion 13 small when an external force acts on the wire connection portion 12, as in Embodiment 1. As a result, the fixing function of the busbar fixing portion 13 with respect to the busbar 80 can be maintained.

Further, according to Embodiment 2, when connecting the terminal 10A to the busbar 80, the position where each positioning reference portion 19 abuts against the front end surface of the arm 82 can be used as a reference for positioning, thereby allowing the terminal 10A to be naturally positioned relative to the busbar 80.

### Embodiment 3

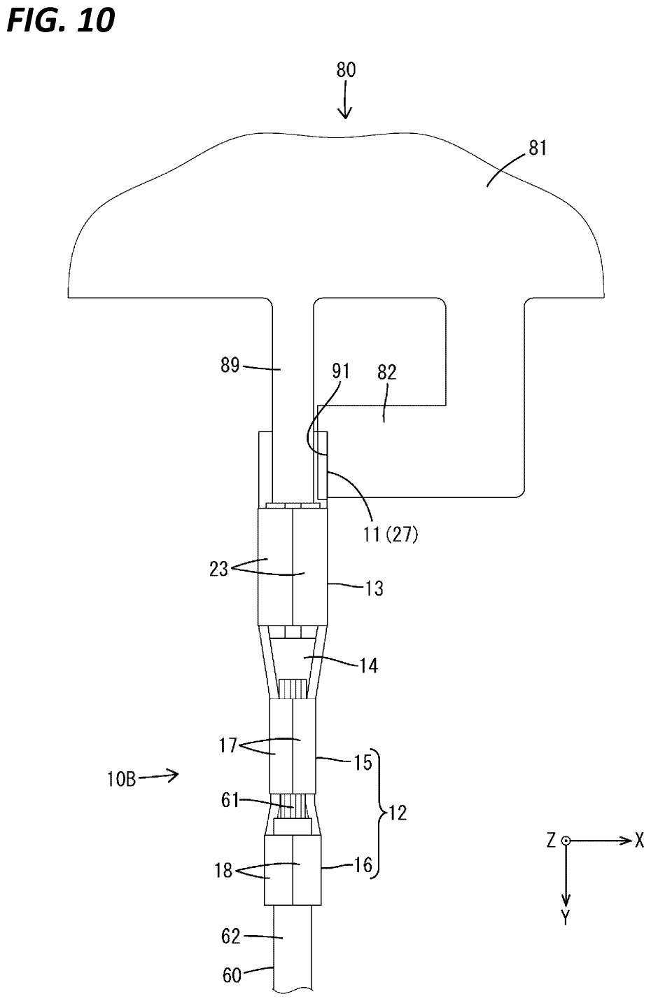

Embodiment 3 of the present disclosure shown in FIG. 10 differs from Embodiment 1 in the structures of the positioning portion 11 of a terminal 10B and the busbar 80. In the following description, parts having the same functions (not limited to the same shapes) as those of Embodiment 1 are given the same reference numerals, and duplicate descriptions are omitted. In FIG. 10, symbols X, Y, Z denote “front”, “left”, and “upper” sides, respectively.

The terminal 10B has a shape extending in the right-left direction, and has a positioning portion 11 at an end on the right end side, a wire connection portion 12 at an end on the left end side, and a busbar fixing portion 13 in an intermediate area in the right-left direction. The terminal 10B has a base 14 extending over the entire length in the left-right direction. The base 14 constitutes bottom wall sections of the positioning portion 11, the wire connection portion 12, and the busbar fixing portion 13.

The positioning portion 11 has a plate piece 27 that rises from the front side on the right end side of the base 14. The positioning portion 11 of Embodiment 3 does not have a function of being fixed to the busbar 80.

The busbar body 81 has a fixed portion 89 having an extending shape on one edge side of the busbar body 81. The arm 82 is located forward of the fixed portion 89. The arm 82 has an L-shaped plate piece shape in a plan view, and has a shape protruding to the left side from the one edge of the busbar body 81 and further extending rearward from the left end side. The rear end surface of the arm 82 is spaced apart from and close to the fixed portion 89. A recess 91 for receiving the plate piece 27 is formed in a cut-out manner in the rear end surface of the arm 82.

In Embodiment 3, the plate piece 27 is formed in a rising manner in advance before the terminal 10B is connected to the busbar. In this state, the base 14 of the busbar fixing portion 13 is arranged below the left end of the fixed portion 89, and the base 14 of the positioning portion 11 is arranged below the right end of the fixed portion 89. The fixing pieces 23 rising upward before being crimped are arranged on the front and rear sides of the left end of the fixed portion 89. Then, the plate piece 27 is fitted into the recess 91 of the arm 82. The connection position (crimp position) of the terminal 10B to the busbar 80 can thus be determined properly. Thereafter, the fixing pieces 23 of the busbar fixing portion 13 are crimped to the fixed portion 89 of the busbar body 81.

In Embodiment 3, the busbar fixing portion 13 can be fixed to the busbar body 81 instead of the arm 82. Further, the terminal 10B can be positioned relative to the arm 82 by the positioning portion 11 having a simple shape without a fixing function.

### Other Embodiments of the Present Disclosure

The above-described Embodiments 1 to 3 disclosed herein are illustrative in all respects and should not be considered restrictive.

In the above-described Embodiments 1 to 3, the wire connection portion is configured by two separate portions, namely the wire barrel portion that is electrically connected to the conductor of the electric wire, and the insulation barrel portion that is mechanically connected to the coating of the electric wire. In contrast, according to other embodiments, the wire connection portion may alternatively be constituted by of a common barrel portion that is electrically and mechanically connected to the conductor of the wire.

In the above-described Embodiments 1 to 3, the busbar fixing portion has a pair of fixing pieces and is crimped and fixed to the busbar. In contrast, according to other embodiments, the busbar fixing portion may alternatively be fixed to the busbar by means of welding or the like, and the shape thereof is not specifically limited.

In the above-described Embodiments 1 to 3, the busbar fixing portion and the wire connecting portion are adjacent to each other. In contrast, according to other embodiments, the busbar fixing portion and the wire connection portion may be arranged next to each other via a portion having different functions from these portions.

In the above-described Embodiments 1 and 2, the positioning portion has one positioning piece. In contrast, according to other embodiments, the positioning portion is not specifically limited as long as it has a shape that allows the terminal to be positioned relative to the busbar; for example, the positioning portion may be constituted by a pair of positioning pieces.

In the above-described Embodiment 2, the stopper portion has a pair of stopper pieces. In contrast, according to other embodiments, the stopper portion is not specifically limited as long as it has a shape that can stop movement of the terminal; for example, the stopper portion may be constituted by only one stopper piece.

### LIST OF REFERENCE NUMERALS

10, 10A, 10B Terminal
11 Positioning portion
12 Wire connection portion
13 Busbar fixing portion
14 Base
15 Wire barrel portion
16 Insulation barrel portion
17 Barrel piece (of wire barrel portion)
18 Barrel piece (of insulation barrel portion)
19 Positioning reference portion
21 Positioning piece
22 Escape space
23 Fixing piece
25 Stopper portion
26 Stopper piece
27 Plate piece
60 Electric wire
61 Conductor
62 Coating
80 Busbar
81 Busbar body
82 Arm
83 Through-hole
84 Arm body
85 Joint portion
86 Bent portion
87 First arm portion
88 Second arm portion
89 Fixed portion
91 Recess

1. A terminal to be connected to a busbar having an arm extending from a busbar body, the terminal having a shape extending in a front-back direction as a whole, the terminal comprising:
a wire connection portion to which an electric wire is to be electrically connected;
a busbar fixing portion to be fixed and electrically connected to the busbar body or the arm; and
a positioning portion for positioning the terminal relative to the arm,
wherein the busbar fixing portion is located between the wire connection portion and the positioning portion,
the positioning portion has a positioning reference portion and is arranged at a front end of the terminal, and
the positioning reference portion is aligned with a reference line extending in a left-right direction relative to a surface of the arm that extends in the left-right direction.

2. The terminal according to claim 1, wherein the positioning portion is fixed to the arm.

3. The terminal according to claim 1, wherein the positioning reference portion constitutes a front end surface of the positioning portion and is aligned with the same position in the front-back direction as a front end surface of the arm.

4. The terminal according to claim 1, wherein the positioning portion has a stopper portion that is not elastically deformable, and the stopper portion has a positioning reference portion at a position at which the stopper portion faces a front end surface of the arm so as to be able to come into contact therewith.

5. A connection structure between a terminal and a busbar, the connection structure comprising:
the terminal according to claim 1; and
the busbar,
wherein the arm has:
an arm body extending in the front-back direction from one end surface to another end surface; and
a joint portion extending in a left-right direction intersecting with an extension direction of the arm body and connecting the arm body and the busbar body,
the positioning portion is located on the one end surface side of the arm body, and
the busbar fixing portion is located on the other end surface side of the arm body.
